(19) United States
(12) Patent Application Publication
(10) Pub. No.: US 2014/0075935 A1
(43) Pub. Date: Mar. 20, 2014

(54) TURBO-COMPOUND SYSTEM, IN PARTICULAR OF A MOTOR VEHICLE

(71) Applicant: Markus Kley, Ellwangen (DE)

(72) Inventor: Markus Kley, Ellwangen (DE)

(73) Assignee: VOITH PATENT GMBH, Heidenheim (DE)

(21) Appl. No.: 13/985,210

(22) PCT Filed: Feb. 18, 2012
(86) PCT No.: PCT/EP2012/000730

§ 371 Date: Dec. 6, 2013

(30) Foreign Application Priority Data
Mar. 2, 2011 (DE) 10 2011 012 861.1

(51) Int. Cl. F02B 37/013

(52) U.S. Cl. CPC F02B 37/013
USPC 60/605.1

(57) ABSTRACT

The invention relates to a turbo-compound system, in particular of a motor vehicle having an internal combustion engine which has an output shaft; having an exhaust-gas power turbine which is arranged in the exhaust-gas flow of the internal combustion engine and has an impeller wheel which is mounted fixedly on a turbine shaft so as to rotate with it; the exhaust-gas power turbine is drive-connected via a step-up gear mechanism to the output shaft of the internal combustion engine, in order to transmit drive power via the step-up gear mechanism to the output shaft; having a hydrodynamic coupling which has an impeller and a turbine wheel which form, with one another, a toroidal working chamber which can be filled with working medium via an inlet, in order to transmit torque hydrodynamically from the impeller to the turbine wheel; wherein at least one gearwheel of the step-up gear mechanism is lubricated with working medium of the hydrodynamic coupling, and the step-up gear mechanism is arranged in the drive connection between the hydrodynamic coupling and the exhaust-gas power turbine. The invention is characterized in that the step-up gear mechanism is configured as a planetary gear mechanism, comprising a sun gear, at least one planetary gear, which is mounted on a planetary carrier, and an internal gear which are in engagement with one another; and a lubricant channel is arranged in the planetary carrier in order to lubricate at least the sun gear, internal gear and/or at least one planetary gear with working medium.

The present invention concerns a turbo-compound system, that is to say a system in a drive train, in particular of a motor vehicle, fitted with an internal combustion engine for driving the drive train, in which exhaust-gas flow an exhaust-gas power turbine is arranged. The exhaust-gas power turbine can be arranged for instance in the exhaust-gas flow before or after the exhaust gas turbine of an exhaust-gas turbocharger.

Energy is extracted from the exhaust gas of the internal combustion engine by means of the exhaust-gas power turbine and transformed into mechanical energy or into drive power. Said energy then is used for additional drive of the output shaft of the internal combustion engine, usually its crankshaft.

Such turbo-compound systems are known. Thus, document EP 0 751 027 B1 describes the arrangement of a hydrodynamic coupling in such a turbo-compound system in order to transmit the energy recovered from the exhaust gas of the internal combustion engine from an exhaust-gas power turbine to the crankshaft. The hydrodynamic coupling includes to that end an impeller and a turbine wheel, which together form a working chamber which can be filled with a working medium, in order to transmit torque hydrodynamically from the impeller to the turbine wheel. A transmission is hence coupled to the exhaust-gas power turbine, which is configured as a spur gear transmission, comprising two gearwheels. A gearwheel is connected to the impeller, which gearwheel meshes with a gearwheel of the turbine shaft of the exhaust-gas turbine. An output shaft is fixedly connected to the turbine wheel, which shaft has a central working medium supply channel, by means of which working medium can be conveyed to the working chamber. Simultaneously, a partial flow is dosed and branched off for lubricating a bearing assembly on which the impeller is supported.

The relatively high radial forces occurring during operation at such spur gear transmissions are generally detrimental, forces which impose high constraints to the mounting of the intermeshing gearwheels. This is especially disadvantageous during use in turbo-compound systems with fast rotating exhaust gas turbines. Moreover only relatively low gear ratios can be realised with compact spur gear transmissions so that the intermeshing gearwheels should be configured relatively large. Finally, with spur gear transmissions, the shafts arranged in driving connection with one another via the spur gears should be mounted constantly parallel to one another. This again leads to a larger construction space of such a transmission.

The object of the present invention is to provide a turbo-compound system, which is improved with respect to the embodiments according to the prior art. In particular, the space requirements of such a turbo-compound system should be reduced. Simultaneously, an optimal and effective lubrication of the bearing assembly of the transmission of the turbo-compound system must be guaranteed.

The object of the invention is solved with a turbo-compound system exhibiting the features of claim 1. Advantageous and particularly appropriate embodiments of the invention are disclosed in the dependent claims.

A turbo-compound system according to the invention, in particular of a motor vehicle, contains an internal combustion engine, which has an output shaft as well as an exhaust-gas power turbine which is arranged in the exhaust-gas flow of the internal combustion engine and includes a impeller wheel, which is mounted in an torque-proof manner on a turbine shaft. The exhaust-gas power turbine is hence in a drive connection with the output shaft of the internal combustion engine via a step-up gear mechanism in order to transmit drive power via the step-up gear mechanism to the output shaft. Moreover, a hydrodynamic coupling is provided which has an impeller and a turbine wheel, which form together a toroidal working chamber which can be filled with working medium via an inlet, in order to transmit torque hydrodynamically from the impeller to the turbine wheel. At least one gearwheel of the step-up gear mechanism is lubricated with working medium of the hydrodynamic coupling. The step-up gear mechanism is moreover arranged in a drive connection between the hydrodynamic coupling and the exhaust-gas power turbine.

According to the invention, the step-up gear mechanism is configured as a planetary gear, comprising a sungear, at least one planetary gear and an internal gear, which are in engagement with one another. The one planetary gear or a plurality of planetary gears is mounted on a planetary carrier. A lubricant channel for lubricating with working medium at least the sungear, internal gear and/or at least the one planetary gear or the several planetary gears is arranged in the planetary carrier.

The impeller or the turbine wheel is advantageously mounted in a torque-proof manner on an input shaft. In so doing, a common working medium supply is associated with the hydrodynamic coupling and the step-up gear mechanism, which supply is arranged in the input shaft and is connected or can be connected in a flow-guiding manner to the inlet of the hydrodynamic coupling. Working medium can be conveyed to the working chamber of the hydrodynamic coupling via the common working medium supply and simultaneously the bearings of the planetary gear and preferably the planetary gear bearings are lubricated optimally. The lifetime of such a turbo-compound system is hereby considerably increased.

The invention will now be described below by way of example using exemplary embodiments and the figures.

The figures are as follows:

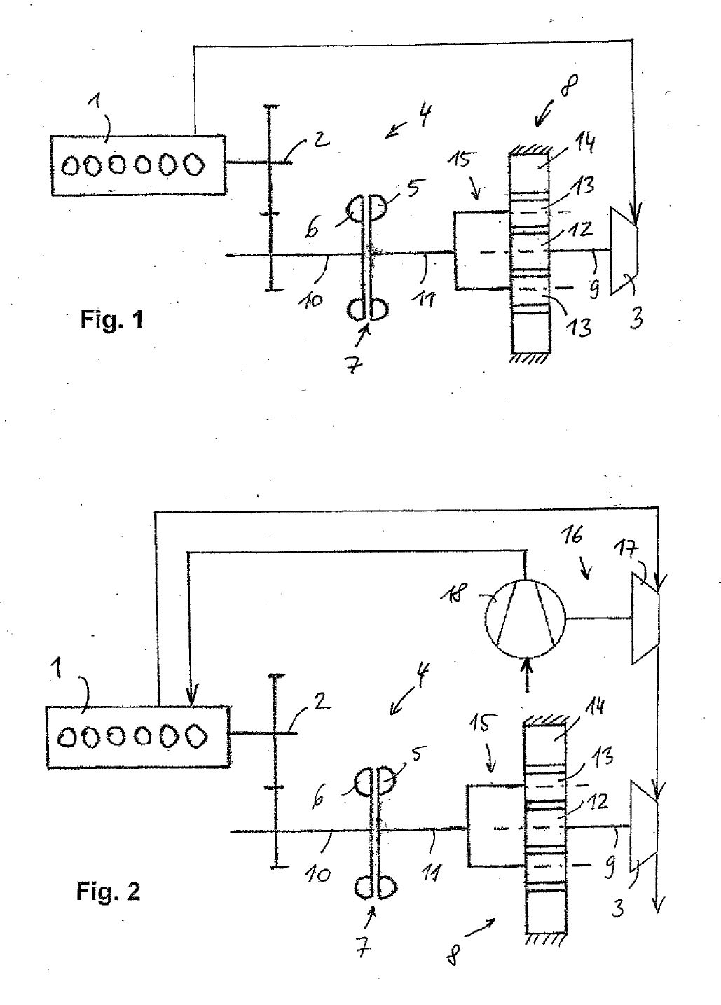

FIG. 1 shows a principle assembly of the drive connection between the exhaust-gas power turbine and the crankshaft of the internal combustion engine;

FIG. 2 shows an embodiment according to FIG. 1 having an additional exhaust-gas turbocharger;

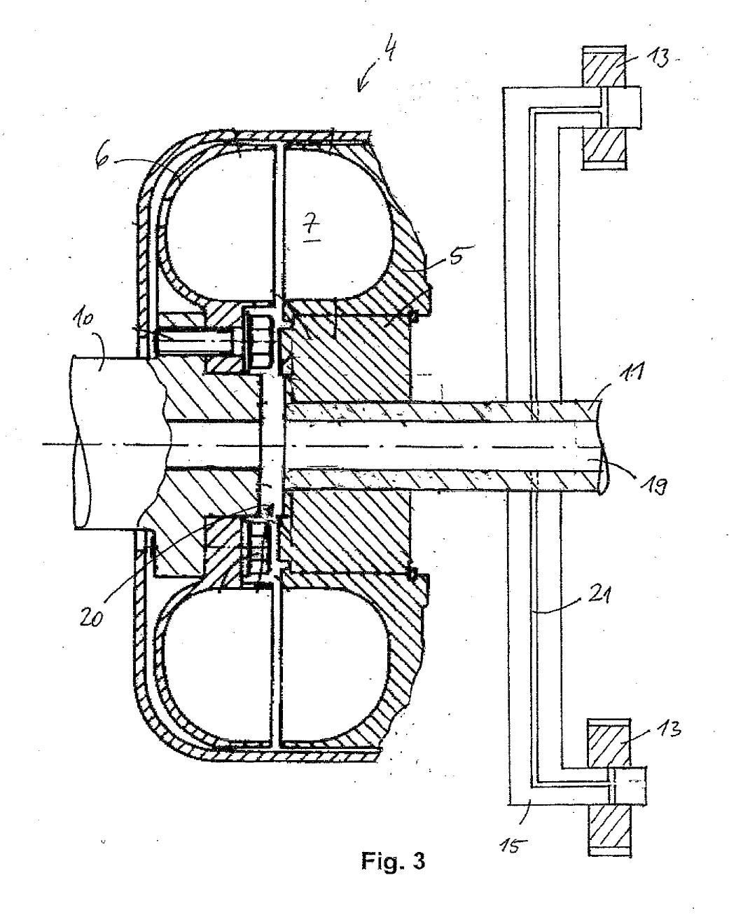

FIG. 3 shows a preferred embodiment of a hydrodynamic coupling of the turbo-compound system.

FIG. 1 shows a drive train between an exhaust-gas power turbine 3 and an output shaft 2, for instance a crankshaft of an internal combustion engine 1. A step-up gear mechanism 8 as well as a hydrodynamic coupling 4 are arranged behind one another in the power transmission direction of the exhaust-gas power turbine 3 to the internal combustion engine 1. The hydrodynamic coupling 4 includes an impeller 5 as well as a turbine wheel 6, which form a working chamber 7 in which a hydrodynamic circular flow can form. To do so, the impeller 5 is connected in this case in a torque-proof manner to an input shaft 11 and the turbine wheel 6 is also connected fixedly to an output shaft 10 of the hydrodynamic coupling 4. The latter is here in driving connection with the output shaft 2 of the internal combustion engine 1 via a pair of gearwheels. It is advantageous that the hydrodynamic coupling 4 is configured as an adjustable coupling.

According to the invention, the step-up gear mechanism 8 is configured as a planetary gear, comprising a sungear 12, two planetary gears 13 as well as an internal gear 14. It is naturally quite possible to provide fewer or more planetary gears instead of both planetary gears 13 represented.

A planetary carrier 15 is provided for mounting the planetary gears 13, which carrier is connected fixedly to the input shaft 11 and forms the secondary side of the step-up gear mechanism 8. The planetary carrier 15 also could consist of the input shaft 11.

The sungear 12 is connected in a torque-proof manner on the primary side of the step-up gear mechanism 8, to a turbine shaft 9 on which a turbine wheel, non-illustrated, is arranged in a torque-proof manner.

In the present case, the internal gear 14 is lightly fitted which however is not compulsory.

The mode of operation of the drive train illustrated is as follows: The exhaust gas coming out of internal combustion engine 1 acts upon the turbine impeller of the exhaust-gas power turbine 3 which enables to transmit drive power to the sungear 12 via the turbine shaft 9. The planetary gears 13 intermeshing with the sungear 12 and the internal gear 14 transmit the drive power to the impeller 5 via the planetary carrier 15 and the input shaft 11. When filling the working chamber 7, preferably in the case of a plenary fill-up, the torque respectively the rotational power of the input shaft 11 is transmitted to the output shaft 2 of the internal combustion engine 11 via the turbine wheel 6, the output shaft 10 and the pair of gearwheels.

FIG. 2 illustrates the subject-matter of FIG. 1 according to a further embodiment. In so doing, the substantially identical constitutive elements are indicated by the same reference signs.

In addition to the exhaust-gas power turbine 3, an exhaust-gas turbine 17 of an exhaust-gas turbocharger 16 is provided, which exhaust-gas turbine is connected upstream of the exhaust-gas power turbine 3 as seen in the flow direction of the exhaust gas. Consequently, the exhaust gas coming out of the internal combustion engine 1 first of all acts upon the exhaust gas turbine 17. The exhaust gas coming out of the exhaust gas turbine 17 or flowing past said turbine is conveyed to the exhaust-gas power turbine 3. A fresh air compressor 18 of the exhaust-gas turbocharger 16 is in driving connection with the exhaust gas turbine 17 to compress an air flow sucked-in from the surrounding atmosphere and to convey it to the internal combustion engine 1 so as to supercharge the same.

As can be seen in FIGS. 1 and 2, the output shaft 10, the input shaft 11 as well as the turbine shaft 9 are arranged concentrically to one another. This should however not be the case compulsorily.

FIG. 3 shows a preferred embodiment of the hydrodynamic coupling 4 of the turbo-compound system according to the invention in an axial section through the rotational axis of the hydrodynamic coupling 4. Here also, the identical constitutive elements are indicated by the same reference signs.

As can be seen in FIG. 3, an axial bore is located respectively in the output shaft 10 as well as in the input shaft 11. The latter or both serve as a common working medium supply 19, associated with the hydrodynamic coupling 4 as well as the step-up gear mechanism 8 (see FIGS. 1 and 2). Naturally, the axial bore could be located exclusively in the output shaft 10 or the input shaft 11 or only one of both bores can be used for supplying the working medium. In the present case, the output shaft 10 and the input shaft 11 are arranged concentrically to one another, whereas their surfaces facing one another form a gap. So a partial flow can reach from the working medium supply 19 in the area of the separating gap between the impeller 5 and the turbine wheel 6 (plane of symmetry) and an intake 20, into the working compartment 7 so as to fill it.

The planetary carrier 15 is configured in a torque-proof manner with the input shaft 11 on the inlet side of the hydrodynamic coupling 4. The latter could also be designed integrally with the input shaft 11.

The planetary carrier 15 has in its internal section a lubricant channel 21 which is connected to the working medium supply 19 in a flow-guiding manner. The planetary carrier 15 also has a boom comprising a first section extending in radial direction as well as a second section extending in axial direction. A planetary gear 13 is mounted respectively on the latter. The number of booms depends on the number of planetary gears 13. The lubricant channel 21 emerges in this case in the section of the boom extending in axial direction, and more precisely in the area of the bearing assembly of the planetary gear 13, for the lubrication thereof.

The lubricant channel 21 can also be used for lubricating a bearing assembly, non-illustrated, of the internal gear 14 and/or of the sungear 12. Additionally, the lubricant channel can emerge in the region of the bearing assembly of the corresponding gearwheel.

The lubricant channel 21 can be provided via a plurality of radial and/or axial bores in the planetary carrier 15.

The assembly according to the invention provides the following advantages: Due to the incorporation of a planetary gear compared to the spur gear transmission, relatively minimal radial forces are obtained during the operation of the exhaust-gas power turbine, which enables to reduce the stress on the bearing assembly of the transmission. At the same time, the planetary gear enables to reach relatively high gear ratios, with a compact design of the transmission simultaneously and hence of the whole turbo-compound system. Finally, the construction according to the invention enables to configure the input shaft, the output shaft as well as the turbine shaft concentrically to one another which further improves the compactness of the turbo-compound system.

### LIST OF REFERENCE NUMERALS

1 Internal combustion engine
2 Output shaft
3 Exhaust-gas power turbine
4 Hydrodynamic coupling
5 Impeller
6 Turbine wheel
7 Working chamber
8 Step-up gear mechanism
9 Turbine shaft
10 Output shaft
11 Input shaft
12 Sungear
13 Planetary gear
14 Internal gear
15 Planetary carrier
16 Exhaust-gas turbocharger
17 Exhaust-gas turbine
18 Fresh air compressor
19 Working medium supply
20 Inlet
21 Lubricant channel

1. A turbo-compound system, in particular of a motor vehicle,
having an internal combustion engine which has an output shaft;
having an exhaust-gas power turbine, which is arranged in the exhaust-gas flow of the internal combustion engine and has an impeller wheel, which is mounted in a torque-proof manner on a turbine shaft;
the exhaust-gas power turbine is in a drive connection with the output shaft of the internal combustion engine via a step-up gear mechanism in order to transmit drive power via the step-up gear mechanism to the output shaft;
having a hydrodynamic coupling, which has an impeller and a turbine wheel, which form together a toroidal working chamber which can be filled with working medium via an inlet in order to transmit torque hydrodynamically from the impeller to the turbine wheel, wherein
at least one gearwheel of the step-up gear mechanism is lubricated with working medium of the hydrodynamic coupling, and
the step-up gear mechanism is arranged in the drive connection between the hydrodynamic coupling and the exhaust-gas power turbine; characterised in that
the step-up gear mechanism is configured as a planetary gear, comprising a sungear, at least one planetary gear, which is journalled on a planetary carrier and an internal gear, which are in engagement with one another; and
a lubricant channel is arranged in the planetary carrier for lubricating at least the sungear, the internal gear and/or at least one planetary gear with working medium.

2. The turbo-compound system according to claim 1, characterised in that the impeller or the turbine wheel is mounted in a torque-proof manner on an input shaft;
having a common working medium supply associated with the hydrodynamic coupling and the step-up gear mechanism, which is arranged in the input shaft and is connected or can be connected to the intake in a flow-guiding manner; wherein
the lubricant channel is connected in a flow-guiding manner to the common working medium supply.

3. The turbo-compound system according to claim 1, characterised in that the lubricant channel extends substantially in radial direction of the hydrodynamic coupling.

4. The turbo-compound system according to claim 1, characterised in that the turbine shaft of the exhaust-gas power turbine is connected in a torque-proof manner to the sungear or is in driving connection with said sungear or can be brought in such a connection.

5. The turbo-compound system according to claim 1, characterised in that the impeller of the hydrodynamic coupling is connected to the planetary carrier or is in driving connection with said carrier or can be brought in such a connection.

6. The turbo-compound system according to claim 1, characterised in that the lubricant channel emerges in the region of a bearing assembly, via which the internal gear, sungear and/or at least one planetary gear is supported in the planetary gear.

7. The turbo-compound system according to claim 1, characterised in that the output shaft, the coupling shaft and the turbine shaft are arranged concentrically to one another.

8. The turbo-compound system according to claim 1, characterised in that the working medium supply is configured in the form of a channel extending in axial direction through the input shaft, especially over the whole axial length, advantageously emerging in both front sides of the input shaft.

9. The turbo-compound system according to claim 2, characterised in that the lubricant channel extends substantially in radial direction of the hydrodynamic coupling.

10. The turbo-compound system according to claim 2, characterised in that the turbine shaft of the exhaust-gas power turbine is connected in a torque-proof manner to the sungear or is in driving connection with said sungear or can be brought in such a connection.

11. The turbo-compound system according to claim 3, characterised in that the turbine shaft of the exhaust-gas power turbine is connected in a torque-proof manner to the sungear or is in driving connection with said sungear or can be brought in such a connection.

12. The turbo-compound system according to claim 2, characterised in that the impeller of the hydrodynamic coupling is connected to the planetary carrier or is in driving connection with said carrier or can be brought in such a connection.

13. The turbo-compound system according to claim 3, characterised in that the impeller of the hydrodynamic coupling is connected to the planetary carrier or is in driving connection with said carrier or can be brought in such a connection.

14. The turbo-compound system according to claim 4, characterised in that the impeller of the hydrodynamic coupling is connected to the planetary carrier or is in driving connection with said carrier or can be brought in such a connection.

15. The turbo-compound system according to claim 2, characterised in that the lubricant channel emerges in the region of a bearing assembly, via which the internal gear, sungear and/or at least one planetary gear is supported in the planetary gear.

16. The turbo-compound system according to claim 3, characterised in that the lubricant channel emerges in the region of a bearing assembly, via which the internal gear, sungear and/or at least one planetary gear is supported in the planetary gear.

17. The turbo-compound system according to claim 4, characterised in that the lubricant channel emerges in the region of a bearing assembly, via which the internal gear, sungear and/or at least one planetary gear is supported in the planetary gear.

18. The turbo-compound system according to claim 5, characterised in that the lubricant channel emerges in the region of a bearing assembly, via which the internal gear, sungear and/or at least one planetary gear is supported in the planetary gear.

19. The turbo-compound system according to claim 2, characterised in that the output shaft, the coupling shaft and the turbine shaft are arranged concentrically to one another.

20. The turbo-compound system according to claim 3, characterised in that the output shaft, the coupling shaft and the turbine shaft are arranged concentrically to one another.
